(19) United States
(12) Patent Application Publication
(10) Pub. No.: US 2013/0290569 A1
(43) Pub. Date: Oct. 31, 2013

(54) Apparatus and Method for Interconnecting a Portable Electronic Device and a Media System in a Vehicle

(71) Applicants: Wei LUO, Fremont, CA (US); Shaolan WANG, Beijing (CN)

(72) Inventors: Wei LUO, Fremont, CA (US); Shaolan WANG, Beijing (CN)

(73) Assignee: O2MICRO, INC., Santa Clara, CA (US)

(21) Appl. No.: 13/460,074

(22) Filed: Apr. 30, 2012

(51) Int. Cl. G06F 3/00

(52) U.S. Cl. 710/5

(57) ABSTRACT

An apparatus includes a communication module and a processor. The communication module receives an identifier of a portable electronic device when the portable electronic device is coupled to the apparatus. The processor is coupled to the communication module. The processor determines a type of the portable electronic device according to the identifier, receives a first command from the media system, converts the first command into a retrieval command readable by the portable electronic device, and sends the retrieval command to the portable electronic device. The first command includes a first play command instructing the media system to play a first media file stored in the portable electronic device. The portable electronic device sends the first media file to the apparatus in response to the retrieval command.

### BACKGROUND

A portable electronic device, for example, a smart terminal, such as a personal communication device (e.g., iPhone, Windows® enabled smart phone, or Android® enabled smart phone, etc.), an entertainment device (e.g., PlayStation® Portable, etc.), or a computer system (e.g., laptop, iPad, etc.) is popular today for its flexibility, intelligentization, and powerful features. Although people can use the portable electronic device everywhere because of its portability, it is not easy or safe to use the portable electronic device during driving. A vehicle media system, such as an Audio-Video-Navigation (AVN) system, can play audio, play video and can navigate the vehicle to a selected location. However, applications in the vehicle media system are fewer than those in the portable electronic devices.

### SUMMARY

In one embodiment, an apparatus for interconnecting a media system in a vehicle and a portable electronic device is disclosed. The apparatus includes a communication module and a processor. The communication module receives an identifier of the portable electronic device when the portable electronic device is coupled to the apparatus. The processor is coupled to the communication module. The processor determines a type of the portable electronic device according to the identifier, receives a first command from the media system, converts the first command into a retrieval command readable by the portable electronic device, and sends the retrieval command to the portable electronic device. The first command includes a first play command instructing the media system to play a first media file stored in the portable electronic device. The portable electronic device sends the first media file to the apparatus in response to the retrieval command.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates an example of an electronic system, in accordance with one embodiment of the present invention.

FIG. 2 illustrates an example of an electronic system, in accordance with one embodiment of the present invention.

FIG. 2A shows an example of a communication port in the electronic system in FIG. 2, in accordance with one embodiment of the present invention.

FIG. 3 illustrates a flowchart of examples of operations performed by a host when a vehicle media system operates in a master mode while a portable electronic device operates in a slave mode, in accordance with one embodiment of the present invention.

FIG. 3A illustrates an example of a display showing multiple medial file icons after a portable electronic device icon is touched, in accordance with one embodiment of the present invention.

FIG. 4 illustrates a flowchart of examples of operations performed by a host when a vehicle media system operates in a slave mode while a portable electronic device operates in a master mode, in accordance with one embodiment of the present invention.

FIG. 5 illustrates a flowchart of examples of operations performed by a host when a portable electronic device operates in a slave mode while a Goble Position System (GPS) module in a vehicle operates in a master mode, in accordance with one embodiment of the present invention.

FIG. 6 illustrates a flowchart of examples of operations performed by a host when a portable electronic device operates in a slave mode while an auto computer system in a vehicle operates in a master mode, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “sending,” “detecting,” “converting,” “determining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

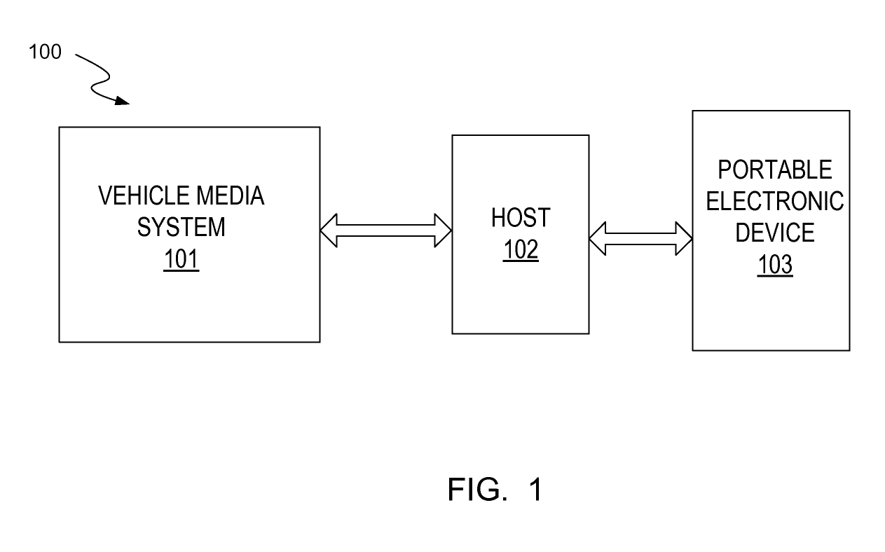

FIG. 1 illustrates an example of an electronic system 100, in accordance with one embodiment of the present invention. A portable electronic device 103 is coupled to a vehicle media system 101 via an apparatus, e.g., a host 102. In one embodiment, the vehicle media system 101, such as an Audio-Video-Navigation (AVN) system, can play audio and video, and navigate the vehicle to a selected location. The portable electronic device 103 can be, but not limited to, a personal communication device (e.g., iPhone, Windows® enabled smart phone, Android® enabled smart phone, Symbian® enabled smart phone, etc.), an entertainment device (e.g., PlayStation®Portable, portable media player, etc.), or a computer system (e.g., iPad, laptop, etc.).

As shown in the example of FIG. 1, to communicate with the vehicle media system 101, the portable electronic device 103 is coupled to the host 102, which is coupled to the vehicle media system 101. More specifically, the host 102 can be coupled to the vehicle media system 101 via a bus, e.g., a universal serial bus (USB). The portable electronic device 103 can be coupled to the host 102 via a bus, for example, a USB, a 1394 bus, or a specified dock connector, for example, an Apple® dock connector (if the portable electronic device 103 is a specified portable electronic device, such as a product from Apple®, e.g., an iPhone or an iPad). In another embodiment, the portable electronic device 103 can be coupled to the host 102 wirelessly or via Bluetooth®. The embodiment shown in FIG. 1 is for illustrative purposes. Other types of connections can also be used to interconnect the vehicle media system 101, the host 102 and the portable electronic device 103, depending on the requirements of particular applications.

In one embodiment, if a command is sent from the vehicle media system 101, for example, a play command instructing the vehicle media system 101 to play one or more media files stored in the portable electronic device 103, the vehicle media system 101 operates in a master mode while the portable electronic device 103 operates in a slave mode. When operating in the master mode, the vehicle media system 101 sends the play command to the portable electronic device 103 via the host 102 to retrieve one or more media files for playing. When operating in the salve mode, the portable electronic device 103 sends the media files to the vehicle media system 101 for playing in response to the play command. By way of example, the play command can be initiated by a user by touching one or more icons on a touch screen (not shown) of the vehicle media system 101. The host 102 receives the play command and converts the play command into a retrieval command readable by the portable electronic device 103 to retrieve the medial files stored in the portable electronic device 103. The host 102 sends the retrieval command to the portable electronic device 103. The portable electronic device 103 sends the media files to the host 102 in response to the retrieval command. In one embodiment, the host 102 receives the media files, decodes the media files and sends the decoded media files to the vehicle media system 101 for playing.

If the play command is sent from the portable electronic device 103, the portable electronic device 103 operates in the master mode while the vehicle media system 101 operates in the slave mode. When operating in the master mode, the portable electronic device 103 sends the play command and the media files to the vehicle media system 101. When operating in the salve mode, the vehicle media system 101 receives and plays the media files from the portable electronic devices 103. By way of example, the play command can be initiated by a user by touching one or more icons on the touching screen (not shown) of the portable electronic device 103. The media files and the play command are sent to the host 102 by the portable electronic device 103. The host 102 receives the play command and the media files, and converts the play command to a command readable by the vehicle media system 101. The host 102 sends the converted play command to the vehicle media system 101. The host 102 can further decode the received media files. In one embodiment, the vehicle media system 101 receives the converted play command and sends a notification signal to the host 102 when the vehicle media system 101 is ready for receiving the media files. Upon receiving the notification signal, the host 102 can send the decoded media files to the vehicle media system 101 for playing.

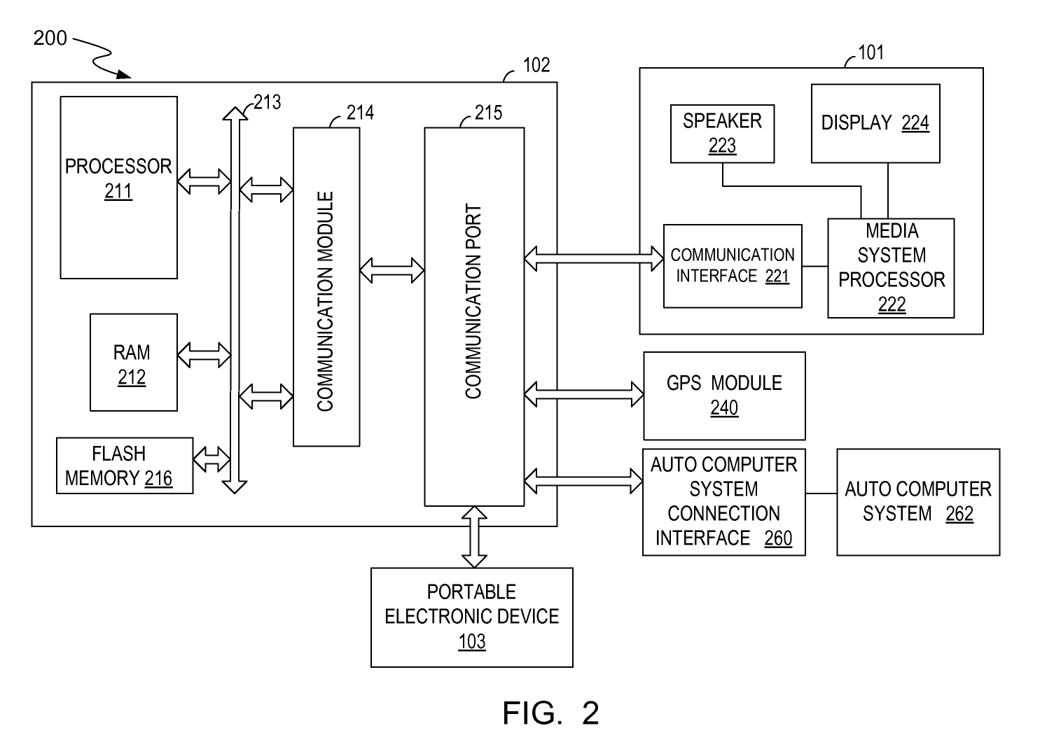

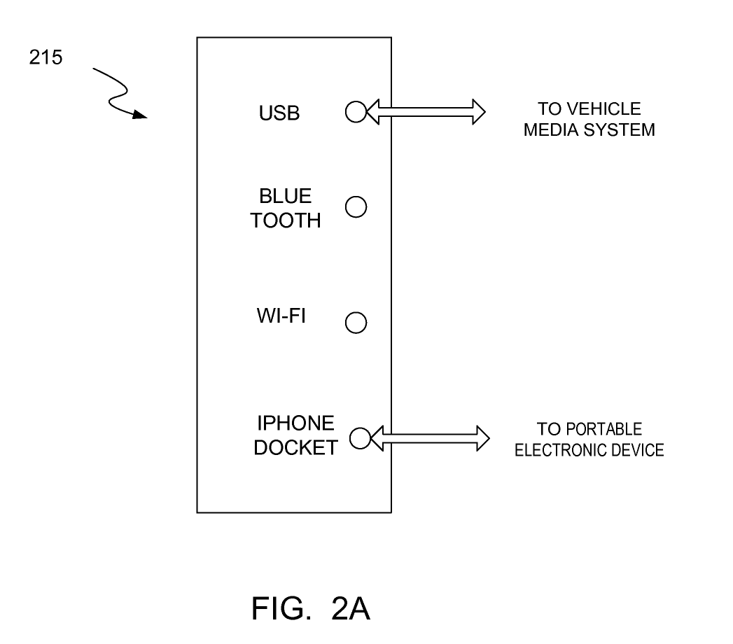

FIG. 2 illustrates an example for the electronic system in FIG. 1, in accordance with one embodiment of the present invention. The vehicle media system 101 includes a communication interface 221, a media system processor 222, a speaker 223, and a display 224. In one embodiment, the communication interface 221 is used to couple the vehicle media system 101 to the host 102. The media system processor 222 can launch a media player application to play a media file sent by the portable electronic device 103. The display 224 can display pictures, videos and other information sent by the portable electronic device 103 depending on the requirements of the vehicle media system 101. In one embodiment, the display 224 is a touch screen which enables a user to interact with the vehicle media system 101 directly without requiring any intermediate devices. The speaker 223 is coupled to the media system processor 222. The structure of the vehicle media system 101 is only for illustrative purposes and other components can be included in the vehicle media system 101 depending on the requirements of particular applications.

As shown in the example of FIG. 2, the host 102 includes a processor 211, computer-readable media, e.g., a random access memory (RAM) 212 and a flash memory 216, a communication module 214, a communication port 215, and a system bus 213. The RAM 212 loads an operating system when the host 102 is powered on. By way of example, the operating system can be, but is not limited to, Linux® based operating system, Windows® operating system, Android® operating system, etc. The RAM 212 also loads a set of programs including computer-executable instructions. The processor 211 executes the programs in the RAM 212 to process the received commands and the data. Other types of storage devices can also be used to store or load the programs and the operating system.

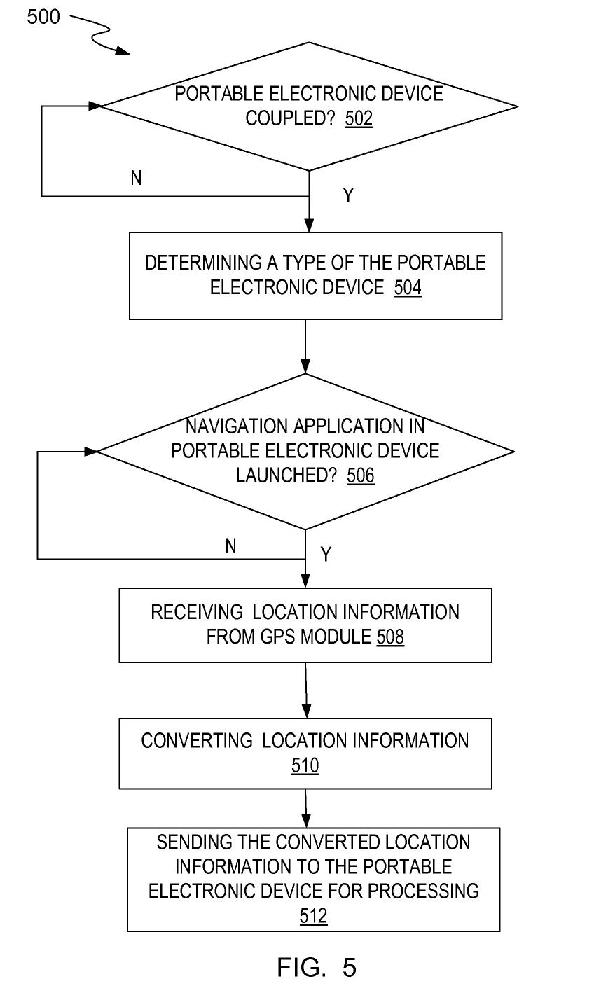

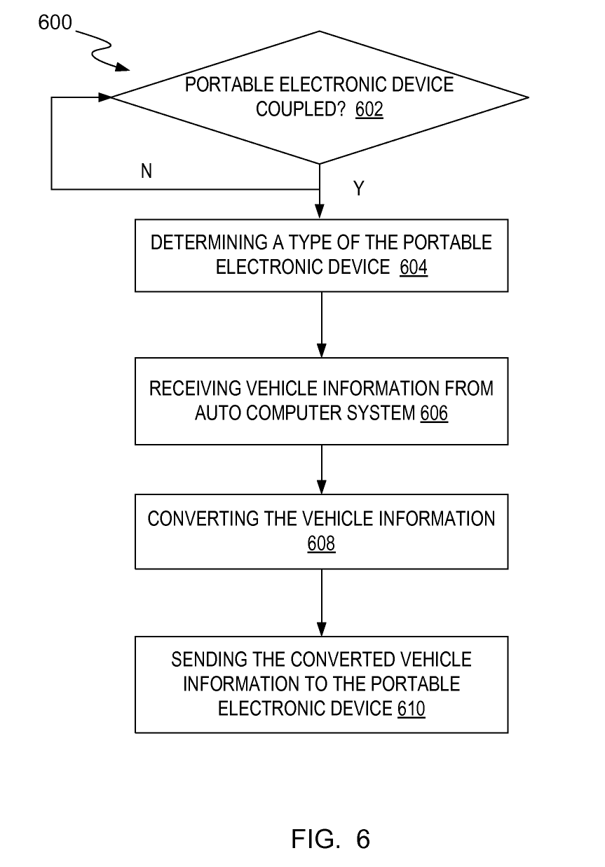

The communication port 215 is used to couple the portable electronic device 103 to the vehicle media system 101. FIG. 2A shows an example for the communication port 215. There are multiple connection ports on the communication port 215, which are configured to couple different types of portable electronic devices to the vehicle media system 101. For illustrative purposes but not limitation, the communication port 215 has a USB port, a Bluetooth® port, a Wi-Fi port, and a specified docket port, for example, an iPhone docket port. Other types of connection ports can be included on the communication port 215, and the number of the connection ports for each type of connection can vary. Each connection port on the communication port 215 is configured to be coupled to the vehicle media system 101 or the portable electronic device 103. For example, the vehicle media system 101 can be coupled to the USB port, and the portable electronic device 103 (e.g., a specified portable electronic device, such as an iPhone) can be coupled to the specified docket port, for example, an iPhone docket port. Moreover, the communication port 215 can be coupled to a GPS module 240 and an auto computer system 262 in the vehicle via an auto computer system connection interface 260, as shown in the example of FIG. 2. The operations of the GPS module 240 and the auto computer system 262 are described in relation to FIG. 5 and FIG. 6, respectively.

The communication module 214 in the host 102 is coupled to the communication port 215 and communicates with the processor 211, the RAM 212 and the flash memory 216 via the system bus 213. In one embodiment, the communication module 214 can receive an identifier of the portable electronic device 103 via the communication port 215 when the portable electronic device 103 is coupled to the host 102, and sends the identifier to the processor 211 for determining a type of the portable electronic device 103.

The processor 211 executes the computer-executable programs stored in the RAM 212 to determine the type of the portable electronic device 103 (for example, iPhone, Windows® enabled smart phone, Android® enabled smart phone, or Symbian® enabled smart phone, etc.) according to the identifier. If a command is sent from the vehicle media system 101, the vehicle media system 101 operates in a master mode while the portable electronic device 103 operates in a slave mode. The processor 211 in the host 102 executes the computer-executable programs stored in the RAM 212 to analyze the command from the vehicle media system 101 and to convert the command into a retrieval command readable by the portable electronic device 103. The processor 211 sends the retrieval command to the portable electronic device 103. In one embodiment, the command from the vehicle media system 101 includes a play command instructing the vehicle media system 101 to play one or more media files stored in the portable electronic device 103. The portable electronic device 103 sends the media files to the host 102 in response to the retrieval command. In one embodiment, the transferred media files can be temporarily stored in the flash memory 216. The host 102 can decode the media files and send the decoded media files to the vehicle media system 101 for playing.

If a command is sent from the portable electronic device 103, the portable electronic device 103 operates in the master mode while the vehicle media system 101 operates in the slave mode. The portable electronic device 103 sends the media files and the command to the host 102 for processing. The processor 211 in the host 102 receives the command from the portable electronic device 103. The flash memory 216 in the host 102 temporarily stores the media files from the portable electronic device 103. The processor 211 executes the computer-executable programs stored in the RAM 212 to convert the command sent from the portable electronic device 103 to a command readable by the vehicle media system 101. The processor 211 sends the converted command to the vehicle media system 101. In one embodiment, the command sent from the portable electronic device 103 includes a play command instructing the vehicle media system 101 to play one or more media files stored in the portable electronic device 103. The host 102 can decode the media files and send the decoded media files to the vehicle media system 101 for playing.

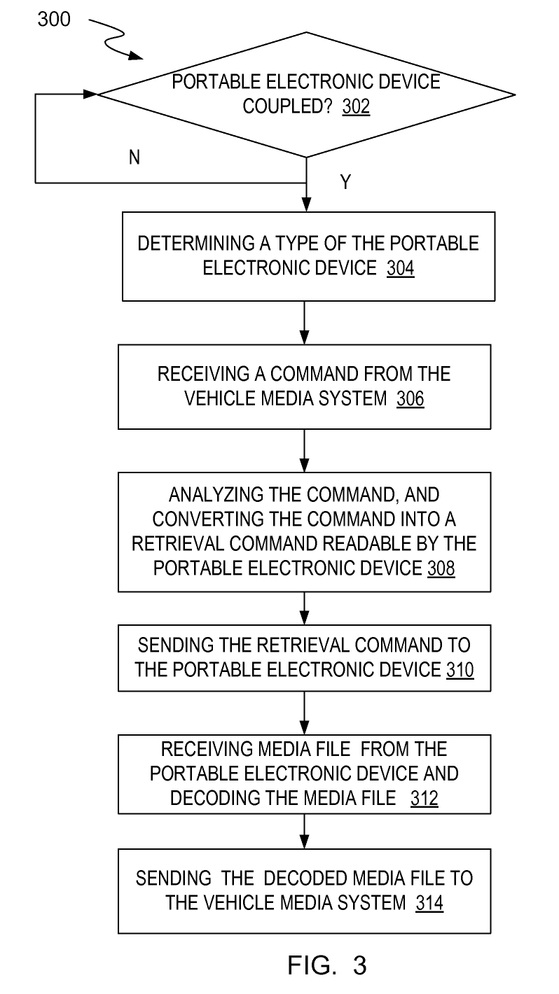

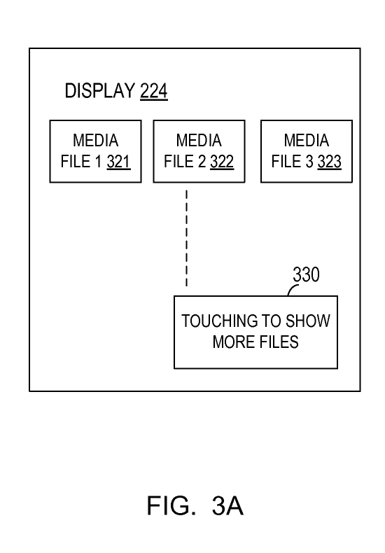

FIG. 3 illustrates a flowchart 300 of operations performed by the host 102 when the vehicle media system 101 operates in the master mode while the portable electronic device 103 operates in the slave mode, in accordance with one embodiment of the present invention. FIG. 3 is described in combination with FIG. 2. Although specific steps are disclosed in FIG. 3, such steps are exemplary. That is, the present invention is well suited to performing various other steps or variations of the steps recited in FIG. 3.

In the example of FIG. 3, in block 302, the host 102 determines if the portable electronic device 103 is coupled to the host 102. If the portable electronic device 103 is coupled to the host 102, the flowchart 300 goes to the block 304; otherwise, the flowchart 300 returns to the block 302. If the portable electronic device 103 is coupled to the host 102, the communication port 215 sends a notification signal to the communication module 214 indicating that the portable electronic device 103 is coupled to the host 102.

In block 304, the host 102 can determine the type of the portable electronic device 103. More specifically, the communication module 214 sends a request to the portable electronic device 103 to get an identifier of the portable electronic device 103. In one embodiment, the RAM 212 stores multiple identifiers, each of which corresponds to a respective type of portable electronic device. The processor 211 executes a type-determining program in the RAM 212 to compare the received identifier with the pre-stored identifiers to determine if the received identifier matches to any identifier stored in the RAM 212. If matched, the processor 211 can determine the type of the portable electronic device 103.

In one embodiment, the RAM 212 includes various programs, each of which corresponds to a type of the portable electronic device, respectively. After determining the type of the portable electronic device 103, the processor 211 can select and execute a program corresponding to the determined type of the portable electronic device 103. For example, the processor 211 can select and execute a program corresponding to the determined type of the portable electronic device 103 to analyze and process the commands received from the portable electronic device 103. The processor 211 can select and execute another program corresponding to the determined type of the portable electronic device 103 to decode the media files received from the portable electronic device 103.

In one embodiment, the host 102 sends a notification signal to the vehicle media system 101 indicating that the portable electronic device 103 is coupled to the host 102 and to vehicle media system 101. An icon representative of the portable electronic device 103 (hereinafter referred to “portable electronic device icon”) can be shown on the display 224 of the vehicle media system 101 when the type of the portable electronic device 103 is determined by the host 102. In one embodiment, the display 224 is a touch screen, and the user can browse various media files stored in the portable electronic device 103 by touching the portable electronic device icon. Once the portable electronic device icon is touched, as shown in the example of FIG. 3A, multiple media file icons (such as media file 1 321, media file 2 322, media file 3 323, etc.), each of which represents a media file stored in the portable electronic device 103, can be shown on the display 224. Moreover, if the media files are too many to be shown at one time on the display 224, an indication 330 can be shown on the display 224 to instruct the user to touch the screen so that more media files can be shown.

In one embodiment, a command is sent from the vehicle media system 101, for example, a play command instructing the vehicle media system 101 to play one or more media files stored in the portable electronic device 103. Thus, the vehicle media system 101 operates in the master mode while the portable electronic device 103 operates in the slave mode. In one embodiment, the play command can be initiated by the user by touching one or more media file icons on the display 224. Each icon represents one media file. The play command can include an instruction and a parameter (e.g., a file name or a title of the media file), for example, “Play_Music: HelloWorld.mp3.”

In block 306, the host 102 receives the play command from the vehicle media system 101. In block 308, the host 102 analyzes the play command and converts the play command into a retrieval command readable by the portable electronic device 103. More specifically, in one embodiment, the processor 211 executes a command-processing program in the RAM 212 to analyze the play command. The processor 211 obtains the instruction (Play_Music, in this example) and extracts the parameter (“HelloWorld.mp3” in this example) from the received play command. The processor 211 also executes the command-processing program to convert the received play command into the retrieval command readable by the portable electronic device 103 according to the obtained instruction and the extracted parameter. For example, the retrieval command can be “Send_Music: HelloWorld.mp3”.

In block 310, the host 102 sends the retrieval command to the portable electronic device 103. The portable electronic device 103 analyzes the received retrieval command and sends the corresponding media file “HelloWorld.mp3” to the host 102.

In block 312, the host 102 receives the corresponding media file “HelloWorld.mp3” from the portable electronic device 103, and temporarily stores the medial file “HelloWorld.mp3” in the flash memory 216. In one embodiment, the received media file “HelloWorld.mp3” has been encoded in the portable electronic device 103. Thus, the processor 211 in the host 102 executes a decoding program to decode the media file.

The host 102 sends the decoded media file “HelloWorld.mp3” to the vehicle media system 101 for playing, as shown in block 314. In one embodiment, the media system processor 222 in the vehicle media system 101 receives the decoded media file “HelloWorld.mp3”, and launches a media player application in the vehicle media system 101 to play the media file “HelloWorld.mp3” via the speaker 223 and the display 224.

In another embodiment, the play command sent from the vehicle media system 101 can also instruct the portable electronic device 103 to play the media files that are stored in the portable electronic device 103. In one embodiment, the play command can be initiated a user by touching one or more media file icons. Each media file icon represents a respective media file. In one embodiment, when an icon is touched, a dialogue box can be popped out to inquire the user to select either the vehicle media system 101 or the portable electronic device 103 to play the selected media file. If the user selects the vehicle media system 101, then the media file is played by the vehicle media system 101; otherwise, the media file is played by the portable electronic device 103.

When the user selects the portable electronic device 103, the play command instructs the portable electronic device 103 to play the selected media file. The vehicle media system 101 still operates in the master mode, while the portable electronic device 103 operates in the slave mode. In one embodiment, the host 102 receives the play command from the vehicle media system 101, analyzes the play command, and converts the play command into a call-service command. More specifically, the processor 211 calls and executes a command-processing program to obtain the instruction and the parameter in the play command, and converts the play command into the call-service command. The call-service command is sent to the portable electronic device 103. The portable electronic device 103 calls a media player application stored in a storage medium in the portable electronic device 103 in response to the call-service command. The media player application receives the parameter in the call-service command, locates the selected media file indicated by the parameter and plays the selected media file.

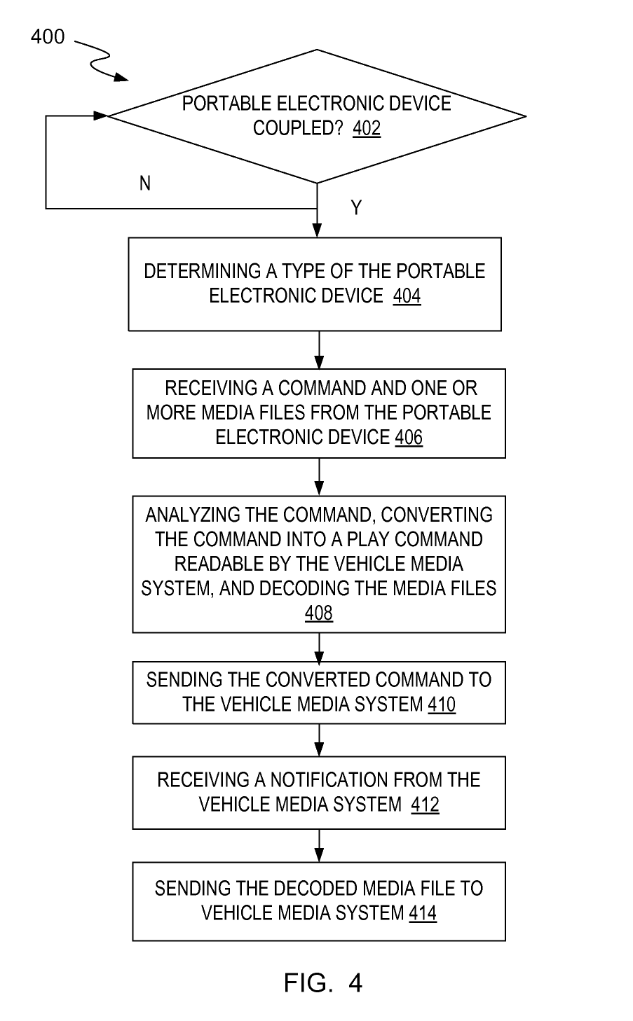

FIG. 4 illustrates a flowchart 400 of operations performed by the host 102 when the vehicle media system 101 operates in the slave mode while the portable electronic device 103 operates in the master mode, in accordance with one embodiment of the present invention. FIG. 4 is described in combination with FIG. 2. Although specific steps are disclosed in FIG. 4, such steps are exemplary. That is, the present invention is well suited to performing various other steps or variations of the steps recited in FIG. 4.

In the example of FIG. 4, in block 402, the host 102 determines if the portable electronic device 103 is coupled to the host 102. If the portable electronic device 103 is coupled to the host 102, the flowchart 400 goes to the block 404; otherwise, the flowchart 400 returns to the block 402. The operations of the host 102 in the block 402 and block 404 are similar to the operations of the host 102 in the blocks 302 and 304.

In block 406, the host 102 receives a command and one or more media files from the portable electronic device 103. In one embodiment, the command includes a play command instructing the vehicle media system 101 to play the designated media files. In block 408, the host 102 analyzes the play command, converts the play command into a play command readable by the vehicle media system 101, and decodes the received media files. More specifically, in one embodiment, the processor 211 executes a command-processing program in the RAM 212 to analyze the play command and to convert the received play command into a play command readable by the vehicle media system 101. The processor 211 further executes a decoding program to decode the received media files, and temporarily stores the decoded media files into the flash memory 216 of the host 102.

In block 410, the host 102 sends the converted play command to the vehicle media system 101. The vehicle media system 101 receives the converted play command, and sends a notification signal to the host 102 indicating that the vehicle media system 101 is ready for receiving the decoded media files. In block 412, the host 102 receives the notification signal from the vehicle media system 101, and sends the decoded media files to the vehicle media system 101 for playing in response to the notification signal, as shown in block 414.

FIG. 5 illustrates a flowchart 500 of operations performed by the host 102 when the portable electronic device 103 operates in the slave mode while a Goble Position System (GPS) module 240 in the vehicle operates in the master mode, in accordance with one embodiment of the present invention. FIG. 5 is described in combination with FIG. 2. Although specific steps are disclosed in FIG. 5, such steps are exemplary. That is, the present invention is well suited to performing various other steps or variations of the steps recited in FIG. 5.

In the example of FIG. 2, the GPS module 240 is coupled to the host 102. The GPS module 240 can calculate the current position of the vehicle by receiving signals from satellites. In the example of FIG. 5, in block 502, the host 102 determines if the portable electronic device 103 is coupled to the host 102. If the portable electronic device 103 is coupled to the host 102, the flowchart 500 goes to the block 504; otherwise, the flowchart 500 returns to the block 502. The operations of the host 102 in the block 502 and block 504 are similar to the operations of the host 102 in the blocks 302 and 304.

In block 506, the host 102 determines if a navigation application is launched in the portable electronic device 103. For example, the host 102 can send an inquiry command to the portable electronic device 103 to check if the navigation application is launched. If the navigation application is launched, the flowchart 500 goes to the block 508; otherwise the flowchart 500 returns to the block 506.

In block 508, the host 102 receives the location information from the GPS module 240. In block 510, the host 102 can convert the received location information into location information readable by the portable electronic device 103. In block 512, the host 102 sends the converted location information to the portable electronic device 103 for processing. In one embodiment, the launched navigation application in the portable electronic system 103 can merge the converted location information with a map and display the location information on the map. Moreover, the map merged with the location information can be further sent to the vehicle media system 101 via the host 102, and displayed on the display 224.

FIG. 6 illustrates a flowchart 600 of operations performed by the host 102 when the portable electronic device 103 operates in the slave mode while the auto computer system 262 in the vehicle operates in the master mode, in accordance with one embodiment of the present invention. FIG. 6 is described in combination with FIG. 2.

In one embodiment, as shown in the example of FIG. 2, the auto computer system 262 is coupled to the host 102 via the auto computer system connection interface 260. The auto computer system 262 can detect operation conditions of the vehicle, such as mileage, tire pressure, oil gauge, etc. The portable electronic device 103 can receive information indicative of the operation conditions of the vehicle from the auto computer system 262 via the host 102, and determine if an alert event occurs.

In block 602, the host 102 determines if the portable electronic device 103 is coupled to the host 102. If the portable electronic device 103 is coupled to the host 102, the flowchart 600 goes to the block 604; otherwise, the flowchart 600 returns to the block 602. The operations of the host 102 in the block 602 and block 604 are similar to the operations of the host 102 in the blocks 302 and 304.

In block 606, the host 102 receives vehicle information from the auto computer system 262. The vehicle information is indicative of the operation conditions of the vehicle, such as mileage, tire pressure, oil gauge, etc. The host 102 converts the received vehicle information in block 608 into vehicle information readable by the portable electronic device 103. In block 610, the host 102 sends the converted vehicle information to the portable electronic device 103 for processing.

In one embodiment, the portable electronic device 103 can determine if an alert event occurs. The alert event occurs, for example, when the oil gauge is less than a predetermined oil amount, or the tire pressure is less than a predetermined tire pressure value. The portable electronic device 103 can generate an alert signal to notify the driver of such alert event. In another embodiment, when an alert event occurs, the portable electronic device 103 can further send an alert message to the vehicle media system 101 via the host 102. The host 102 converts the alert message into an alert message readable by the vehicle media system 101 and sends the converted message to the vehicle media system 101. The vehicle media system 101 can display the alert massage on the display 224.

Other function modules in the vehicle can also be interconnected with the portable electronic device 103 via the host 102 within the scope of the invention. As such, the applications in the portable electronic devices 103 can be shared by the module functions in the vehicle. Thus, more amusement and convenience can be obtained during driving.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An apparatus for interconnecting a portable electronic device and a media system in a vehicle, said apparatus comprising:
a communication module that receives an identifier of said portable electronic device when said portable electronic device is coupled to said apparatus; and
a processor, coupled to said communication module, that determines a type of said portable electronic device according to said identifier, receives a first command from said media system, converts said first command into a retrieval command readable by said portable electronic device, and sends said retrieval command to said portable electronic device,
wherein said first command comprises a first play command instructing said media system to play a first media file stored in said portable electronic device, and wherein said portable electronic device sends said first media file to said apparatus in response to said retrieval command.

2. The apparatus of claim 1, wherein said processor decodes said first media file and sends a decoded first media file to said media system for playing.

3. The apparatus of claim 1, further comprises a communication port that are configured to couple different types of portable electronic devices to said media system.

4. The apparatus of claim 3, wherein said communication port sends a notification signal to said communication module indicating that said portable electronic device is coupled to said apparatus.

5. The apparatus of claim 1, wherein said processor receives a second command from said portable electronic device, converts said second command to a third command readable by said media system, and sends said third command to said media system, and wherein said second command comprises a second play command instructing said media system to play a second media file stored in said portable electronic device.

6. The apparatus of claim 5, wherein said processor receives said second media file, decodes said second media file and sends a decoded second media file to said media system in response to a notification signal indicating that said media system is ready for receiving said decoded second media file.

7. The apparatus of claim 6, wherein said processor sends said decoded second media file to said media system, and wherein said media system plays said decoded second media file.

8. The apparatus of claim 1, wherein an icon indicative of said portable electronic device is displayed on a display in said media system when said type of said portable electronic device is determined by said processor.

9. The apparatus of claim 8, wherein said first command is initiated by touching an icon representative of said first media file stored in said portable electronic device on said display.

10. The apparatus of claim 1, wherein said processor further receives location information from a Global Position System (GPS) module, converts said location information into location information readable by said portable electronic device, and sends converted location information to said portable electronic device.

11. The apparatus of claim 1, wherein said processor further receives information indicative of an operation condition of said vehicle from an auto computer system, converts said information into information readable by the portable electronic device, and sends converted information to said portable electronic device for processing.

12. A method for interconnecting a media system in a vehicle and a portable electronic device, said method comprising:
determining a type of said portable electronic device when said portable electronic device is coupled to said media system;
receiving a first command from said media system;
converting said first command into a retrieval command readable by said portable electronic device;
sending said retrieval command to said portable electronic device; and
sending a first media file in response to said first retrieval command by said portable electronic device,
wherein said first command comprises a first play command instructing said media system to play said first media file stored in said portable electronic device.

13. The method of claim 12, further comprising:
receiving said first media file sent by said portable electronic device in response to said retrieval command;
decoding said first media file; and
sending a decoded first media file to said media system to play.

14. The method of claim 12, further comprising:
receiving a second command from said portable electronic device;
converting said second command into a third command readable by said media system;
sending said third command to said media system,
wherein said second command comprises a second play command instructing said media system to play a second media file stored in said portable electronic device.

15. The method of claim 14, further comprising:
receiving said second media file;
decoding said second media file; and
sending a decoded second media file to said media system in response to a notification signal from said media system,
wherein said notification signal indicates that said media system is ready for receiving said decoded second media file.

16. The method of claim 12, further comprising:
sending a notification signal to said media system indicating that said portable electronic device is connected to said media system.

17. The method of claim 12, further comprising:
displaying an icon representative of said portable electronic device on a display in said media system if said type of said portable electronic device is determined.

18. The method of claim 17, wherein said first command is initiated by touching an icon representative of said first media file on said display.

19. The method of claim 12, further comprising:
receiving location information from a Global Position System (GPS) module;
converting said location information into location information readable by said portable electronic system; and
sending converted location information to said portable electronic device.

20. The method of claim 12, further comprising:
receiving information indicative of an operation condition of said vehicle from an auto computer system in said vehicle;
converting said information into information readable by said portable electronic device; and
sending converted information to said portable electronic device for processing.
